(19) United States
(12) Patent Application Publication
(10) Pub. No.: US 2005/0071181 A1
(43) Pub. Date: Mar. 31, 2005

(54) Method and system for delivering and managing assessments

(76) Inventors: Paul F. Christ, Blue Bell, PA (US); Michael V. Pearson, Kennett Square, PA (US)

Correspondence Address: WEBCOURSE SERVICES, INC., 615 JUNIPER DRIVE, BLUE BELL, PA, 19422, US

(21) Appl. No.: 10/676,917

(22) Filed: Sep. 30, 2003

(51) Int. Cl. G06F 17/60

(52) U.S. Cl. 705/1; 705/10; 705/4

(57) ABSTRACT

A method and system for delivering and managing assessments involving using an interface device, connected to an electronic and/or communications channel(s), to access an assessment delivery and management system in order to provide access to certain information content and to provide access to assessment items. User activity within an interface device occurs within an environment in which multiple components are present in a manner that produces a continuous unified perceptual experience. Thus users can create and modify assessment results while in the presence of the information content, which most likely represents, either directly or indirectly, the material or subject for which an assessment is being created. User activities within one component do not material affect or disturb information in other components unless the user intentionally chooses to alter other components. Modifications to the assessment results may also occur within the continuous unified perceptual experience.

### FEDERALLY SPONSORED RESEARCH

Not Applicable

### SEQUENCE LISTING OR PROGRAM

Not Applicable

1. Field of Invention

This invention generally relates to field of assessment, and more particularly, to a method and system that facilitate the creation and modification of assessment results.

2. Description of Prior Art

There are many situations that require one party to use some method of assessment to gather information on another party. In this context, assessments are means and methods used to evaluate, test, measure and/or other means used by one party to gain insight into another party's understanding, knowledge, comprehension, progress, attitudes, perceptions, skill development, memory and other criteria.

The most common example of this is when a teacher must assess the knowledge that has been absorbed by students. In addition to an academic environment, there are many other situations in which assessment may be used. Some examples may include: a company training its workers on how to use a new technology product; a market research firm asking respondents to a survey to evaluate a new packaging design; or an insurance company determining whether a potential policy holder has read and understands the policy for which they are seeking coverage. These are just a few of many ways in which information assessment may be used.

Until the advent of computer technology, most assessment was limited to using either verbal or handwritten means to gather the information provided by the assessment. For example, in the classroom setting the teacher might ask questions and seek verbal responses or the teacher may use a print format by administering tests or quizzes. However, with improvements in computer technology and, in particular, the advent of computer networks such as the Internet and corporate Intranets, assessments can now be carried out in electronic form. For example, students can take a course over the Internet without the need to be in the classroom and can take tests, quizzes and other assessments by using a computer to access courseware; or a consumer can be recruited by an advertising agency to view and evaluate advertisements that are sent to their interactive television; or a trade show operator can send questionnaires regarding the effectiveness of the show, which are accessible by exhibitors or show attendees via their wireless devices.

Assessment delivered electronically has generally followed a process in which the assessment itself is presented as a stand-alone item and generally isolated from the information content or knowledge source for which the assessment is most likely being used (i.e., material that student must know and for which the assessment is designed to measure). For instance, students may take a test online via computer networks but are only presented with the test questions and not the material which may be the subject of some or all of the test questions.

In practice, delivering online assessment by itself without the presence of the information content or knowledge source for which the assessment was designed to measure is a common procedure and one that most students of online courses as well as standard classroom-based courses are readily familiar. For instance, students must understand material prior to taking the test and may not be permitted to access the material while they take a test (e.g., closed book test). However, the presentation of assessments in this manner is just one way to deliver assessments. There is a level of learning or understanding that can take place when those being assessed are presented with BOTH assessment items and the information content together. For example, assessment can occur in shorter segments and as an ongoing process that occurs as the student is learning and not something that only takes place after all material is presented. Likewise, assessment is not limited to the concept of students taking tests. As previously mentioned, assessment can take place in any situation in which one party seeks insight regarding another party's understanding, knowledge, comprehension, progress, attitudes, perceptions, skill development, memory and other criteria. For instance, assessment may involve reactions, comments, group discussion, file sharing and many other methods that help one party gain insight into another party. Additionally, assessment has application in both academic and non-academic settings.

Finally, assessment does not have to viewed as a task that is confined to a single individual. There may be situations in which two or more individuals can work together in a collaborative way to complete tasks associated with completing an assessment.

For situations in which electronically delivered assessments may benefit from allowing those being assessed to have access to the information content or knowledge source, there is an inherent drawback in the fact that current methods require those being assessed to alternate between the information content or knowledge source(s), and the electronic tools containing the assessment items. That is, the information content for which the assessment is being used and the assessment items are not within a continuous unified perceptual experience (for example see U.S. patent application No. 20030175675).

A continuous unified perceptual experience exists when one or more sensory inputs or stimuli are present, either concurrently or in relevant sequential order, so that the user's overall sensory experience or awareness registers as a single or series of associated and undisturbed events. For the purpose of this invention such an experience takes place within the experience obtained when interacting, either passively or actively, with certain electronic or communications devices. The main principle behind the continuous unified perceptual experience is that the person who is registering the experience when interacting with the electronic and/or communications device is perceiving that the stimuli they are experiencing are linked or unified in a logical or rational manner such as being associated with a specific item or application and/or emanating from a single source. A disruption to the link that establishes the perceived connection of stimuli results in a disruption to the person's perceptual experience. A distinction is not made based on length of time of exposure to the stimuli but on common characteristics that link the stimuli and that these links are relevant within the context of the person's current expectations of the perceptual experience.

For the purpose of this invention, examples may include: information provided through a single computer application such as a single web browser; programming provided through a single analog or digital wireline broadcast source such as cable sources and programming provided through a single analog or digital wireless broadcast source such over-the-air television and radio, satellite, and other wireless applications. In each of these examples someone whose current perceptual experience is focused on the information (i.e., stimuli) provided by these sources recognizes that these are linked as long as the delivery of the stimuli remains undisturbed within the user's expectations of the perceptual experience.

For example, when watching television the viewer may become absorbed with programming offered by a broadcast channel, which contains many sensory stimuli most notably text, video and audio, which the viewer realizes are integrated to produce the programming content. For the viewer the combination of different sensory stimuli offered by the broadcaster produces a unified event. However, if the broadcast channel is changed, then a viewer's perceptual experience has been altered and the viewer's awareness has to some degree shifted away from the programming offered by the previously viewed broadcast channel.

Likewise, when working with programs or applications through a computer interface device, a user's experience is often interrupted by the need to switch between programs or applications in order to complete a task. The switching presents the user with new sensor stimuli either fully or partially in place of the perceptual experience they were sensing before the switching occurred. For example, a user may need to switch from one program or application to another, which may create a situation whereby the program or application the user was working with is now overlaid, either fully or partially, with another program or application. These interruptions in one's perceptual experience may present problems to the user of the interface device as they make certain adjustments to handle the shift in their awareness.

Unfortunately, for those interested in delivering assessment items along with the information content a drawback exists in that present processes require the user to work with information content and assessment items that represent separate sensory experiences. The user is required, in nearly all situations, to make physical and/or mental adjustments or manipulations that at one point in time brings the information content within their sensory experience and another adjustment or manipulation to bring the assessment items into their sensory experience. The act of bringing one of these items into the user's perceptual experience requires that the other item depart the user's perceptual experience either in part or in full.

For example, a teacher may instruct students to visit a number of web sites as part of a class assignment. The teacher would like the means to assess the level of knowledge or experience (or measure some other attribute) gained by the student after visiting the sites. Current assessment delivery options would require the user (student) to first visit the web site. Once the site has been visited, the user can begin to develop his or her response to assessment items. To create responses related to the material found on the web sites, the user has the ability to draw from several sources. One source is to tap into his/her memory of what he/she experienced when visiting the web sites. A second source is to look at a printed form of the web site, which the user may have produced when she/he visited the site. A third source is for the user to retain the web site for viewing on a computer screen (e.g., in a browser).

Yet each of the sources which the student may utilize in order to help with response items holds certain disadvantages to the student when completing the assessment. A disadvantage of relying on memory, is that the student does not have the actual information content in their view and must rely solely on her or his memory of the material on the web site in order to complete the assessment. A failure to remember may require the student to spend extra time revisiting the web site. Clearly if the user's memory is in error the user may enter the wrong information on the assessment.

Disadvantages also exist when the student is referring to the printed representation of the web site. For instance, the user faces the inconvenience of moving his or her eyes away from the electronic assessment items in order to refer back to the printed document. This process has several drawbacks. First, it may potentially increase the time it takes to complete the assessment since the user must move their eyes away from the electronic assessment items in order to focus on the printed material. Second, this method may increase the risk of errors in terms of data entry within the electronic assessment items especially if the user must remove their hands from the interface device in order to handle or manipulate the printed material. Third, this method is clearly expensive in terms of paper and materials since the student must printout the web site. Fourth, many web site cannot be fully printed on common printing paper and often a large part of the page (especially the right portion) often is missing. Fifth, if the student produced the printout some time in the past, it is a possibility that the contents of the actual web site may have changed between the time it was printed out and the time the teacher referred to it in order to develop the assessment. This may result in the student believing their assessment responses are accurate when in fact information has changed and the responses are no longer accurate.

Disadvantage also exists with the option of switching between the web browser that contains the web site that serves as the information content and the computer application containing the assessment items. First, the act of switching between the two items may mean that one item is lost from view either fully or partially. This can increase the time it takes to complete assessment items since the user may need to continually switch between the two items. This may be a particular disadvantage if completion of the assessment must take place within a specific length of time (e.g. timed test). Second, while it is conceivable that the user could manipulate both items so as to make them appear in a way so one item does not overlap or block the other, the act of doing so is time consuming, inconvenient and, for many users, technically challenging. Additionally, this does not qualify as a unified perceptual experience since the items reside in separate applications rather than within a single application.

The disadvantages cited are in some ways solvable within a web browser situation with the use of a coding technique called frames. Frames allow for web browsers to be divided or sectioned off in a way that multiple sources or components, each residing at and being delivered from separate electronic and/or channel locations, can be presented concurrently within a single web browser and in this way produce a continuous unified perceptual experience. However, this method for delivering multiple components within a single web browser contains an inherent disadvantage in that the control of the presentation of the information rests with the source of the information. That is, characteristic about the information presented in the frame such as its size and behavior within the frame may not be controllable by the program that is delivering this information to the users interface device. The lack of presentation control could present problems within the user' web browser. For example, returning to the situation in which the instructor would like his or her students to visit a web site and then have the students respond to questions about the web site, an online assessment delivery process could use frames to achieve this. For instance, the web site may appear in the upper frame of the web browser while the assessment items appear in the lower frame. However, the source of the web site may have control on how the web site appears in the student's web browser. Instead of appearing only in the upper section of the web browser and within the upper frame, the web site may, in fact, take over the entire web browser in a coding technique that is known as “frame busting.” Clearly such a frame busting condition defeats the purpose of try to present both information content and assessment items within a continuous unified perceptual experience.

While a number of previous inventions and proposed inventions have dealt with other issues related to one or more aspects of assessments such as delivery using electronic methods (U.S. Pat. No. 6,146,148), educational game playing (U.S. Pat. No. 5,782,692), scoring or grading (U.S. Pat. No. 6,267,601) or interactive training (U.S. patent application No. 20030044761), prior art is lacking in addressing the issues raised in this invention.

The object of the present invention then is to present a method and system utilizing electronic and/or communications channels that allows users to complete assessment items, while in the presence of certain information content, in a way that provides a continuous unified perceptual experience. Additionally, the invention will allow characteristic of the presentation of the information content and assessment items to be controlled by the method and system presented here.

Other objects and features of the invention and the manner in which the invention achieves its purpose will be appreciated from the foregoing and the following description and the accompanying drawings, which exemplify the invention.

### SUMMARY OF THE INVENTION

The present invention provides a method and system that allows a user to create and modify assessment results from assessment items. The assessment items are primarily developed by one party for the purpose of assessing another party, such as a teacher preparing an assessment for a student. However, the present invention can be used in other situations where the purpose is for one party to gain insight into another party's understanding, knowledge, comprehension, progress, attitudes, perceptions, skill development, memory and other criteria.

In the preferred embodiment a user will gain access, through an interface device, to an assessment delivery and management system that includes materials for creating and modifying assessment results. In this invention, the user develops assessment results via an interface device connected to an electronic and/or communications channel(s). In the preferred embodiment the assessment delivery and management system manages the concurrent delivery to the user's interface device of multiple components including: 1) a component containing information content, which most likely represents, either directly or indirectly, the material or subject for which assessment items were created and 2) a component containing assessment items from which assessment results will be created.

The manner in which the system manages the delivery of multiple components to the user's interface device is in a form that produces a continuous unified perceptual experience. A continuous unified perceptual experience exists when one or more sensory inputs or stimuli are present, either concurrently or in a sequential order, so that the user's overall experience or awareness registers as a single or series of associated and undisturbed events. Additionally, the invention allows for one or more components to exist as individualized contained elements within a general presentation scheme managed by the assessment delivery and management system. In this way certain characteristics of the components that exist as individualized contained elements are controlled by the assessment delivery and management system.

An additional feature of this invention is to allow for modification of previously created assessment results, which includes additions, deletions, and other adjustments.

### BRIEF DESCRIPTION OF DRAWINGS

FIG. 1 shows a flow diagram offering a basic overview of this invention.

FIG. 2 shows a diagram of an additional presentation of the invention represented within technology components.

FIGS. 3A, 3B and 3C illustrate the presence of multiple components within a user's interface device.

FIGS. 4A and 4B show conceptual representations of a single web browser containing multiple components.

FIG. 5 shows a flow diagram representing the initial steps involved in the creating or modifying stored assessments results.

FIG. 6 shows a flow diagram representing the steps involving the process of creating new stored assessments results.

FIG. 7 shows a flow diagram representing the steps involving the process for modifying stored assessment results.

FIG. 8 shows a flow diagram representing the steps involving the process for continuing the process related to creating or modifying stored assessment results.

FIGS. 9A, 9B, 9C and 9D show additional representations of multiple components within a web browser.

### DETAILED DESCRIPTION OF THE PREFERRED EMBODIMENT

Explanation of Assessment Delivery and Management System

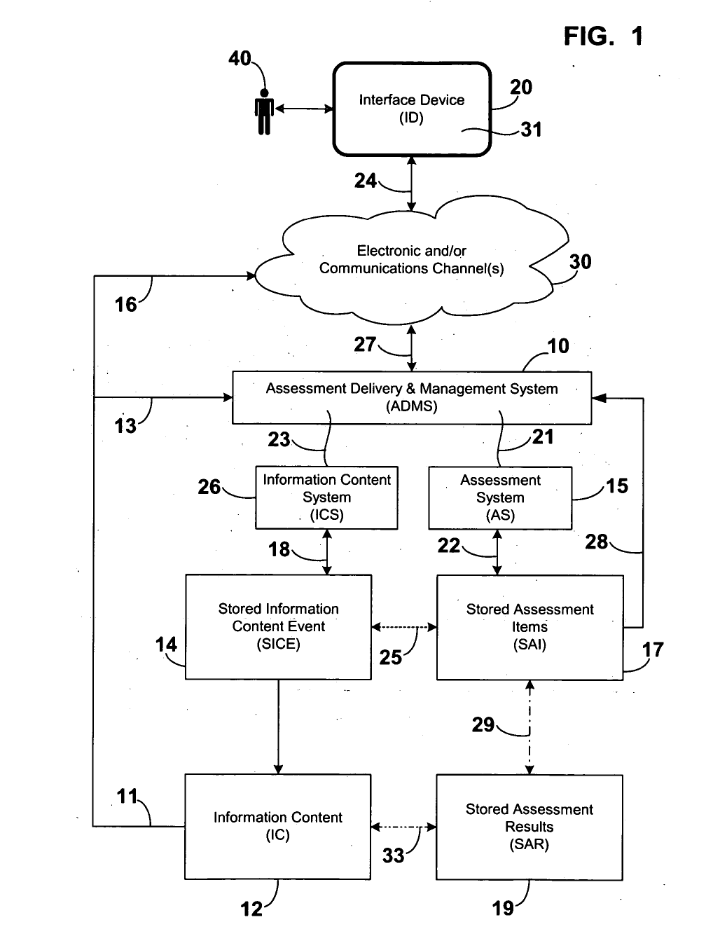

In the drawings, wherein like reference numerals indicate like elements, there is illustrated in FIG. 1 a flow diagram offering a basic overview of this invention. In the preferred embodiment, a user 40 will use an interface device (ID) 20 to access an assessment delivery and management system (ADMS) 10 in which materials are provided for creating and modifying assessment results.

For the purpose of this invention, the functions of the ADMS 10 include, but are not limited to:
1. providing information content system (ICS) 26 that assists in locating and providing access to a stored information content event (SICE) 14, which includes the information related to certain information content 12;
2. providing an assessment system (AS) 15 that assists in locating and providing access to stored assessment items (SAI) 17 that are associated 25 with IC 12 via the SICE 14;
3. allowing a user 40 to create stored assessment results (SAR) 19 or, possibly, modify existing SAR 19;
4. providing a general presentation scheme (GPS) 31 that allows for the arrangement of two or more components, whose delivery is managed by the ADMS 10, to exist within the ID 20 of a user 40;
5. locating the IC 12 via its electronic and/or communications channel(s) location(s) stored within the SICE 14, and managing the delivery, within a GPS 31, of the IC 12 to the ID 20 of a user 40;
6. locating the SAI 17 associated with the IC 12 and managing the delivery, within a GPS 31, of the SAI 17 to the ID 20 of a user 40;
7. managing the delivery, within a GPS 31, to the ID 20 of both the IC 12, identified within the SICE 14, and its associated 25 SAI 17 in a manner that produces a continuous unified perceptual experience;
8. creating stored assessment results (SAR) 19 upon partial or full completion of assessment activity by the user 40;
9. designating an association 29 between the SAR 19 and the SAI 17 upon partial or full completion of assessment activity by the user 40;
10. allowing, under certain conditions, for the user 40 to modify or otherwise adjust information related to the SAR 19;
11. allowing the user 40 to access a SAI 17 and its associated 29 SAR 19, including accessing individual assessment items, for purposes that may include but are not limited to using these for review and for sharing with other users; and
12. associating all saved items to the user 40 including, but not limited to, the SAR 19.

The functions of the ADMS 10 explained above are mentioned as these relate to the current invention. The ADMS 10 may by itself or as part of a system having greater functionality, offer other functions most notably providing the necessary mechanisms to allow one party to create assessments for a user 40.

Invention Overview

Again referring to FIG. 1, the user 40 will access the ADMS 10 via an ID 20 that connects 24 to one or more electronic and/or communications channels 30, such as, but not exclusively, computer networks and sources such as Internet, Intranet, and other public and private networks; and/or digital and analog transmission networks and sources such as over-the-air broadcast sources, satellite sources and other wireless sources. Using the ID 20 a user 40, who is uniquely identified, will gain access to the ADMS 10, which allows the user 40 to create SAR 19 (e.g., create answers to questions) and, possibly, modify SAR 19. The ADMS 10, which connects 27 to one or more electronic and/or communication channels 30 may exist as a stand-alone item or may reside inside of other items such as software used to create educational material (e.g., courseware), research testing software or other software that incorporates a component for creating and, possibly, modifying assessment results.

The process of creating SAR 19 begins with the ADMS 10 providing and managing delivery to the user's ID 20 of certain components including a component containing IC 12 and a component containing SAI 17. The IC 12 and the SAI 17 are, most likely, materials provided either directly or indirectly by another party (e.g., course instructor). The ADMS 10, within a GPS 31, allows both the IC 12 and the SAI 17 to exist concurrently within the user's ID 20.

Thus, with the IC 12 and the SAI 17 existing concurrently within the user's ID 20, an aspect of this invention is to allow a user 40 to create SAR 19 that are either directly or indirectly associated with an IC 12 and to allow for the user 40 to create, and possibly modify, assessment results (e.g., take a test or modify test answers) while both the IC 12 and SAI 17 exists within the user's ID 20.

Managing Delivery of Information Content

The ADMS 10 contains 23 an ICS 26 that includes features for locating the SICE 14 that will be associated with the assessment delivery process. In particular, the ICS 26 will locate 18, within the SICE 14, stored information related to a certain IC 12, accessible via electronic and/or communications channel(s), that was created, referenced, linked or otherwise supplied by one party (e.g., teacher) for the purpose of using as part of the assessment process of another party (e.g., students). Information related to the IC 12 includes, but is not limited to, the electronic and/or communications channel(s) location in which the IC 12 resides.

There are two options that may be available through the ADMS 10 for managing the delivery of the IC 12 to the ID 20. In option one, the IC 12 follows a path 11 to 13 in which the IC 12 is delivered directly through the ADMS 10 which then manages delivery of the IC 12 through the ADMS's connection(s) 27 to an electronic and/or communications channel(s) 30 and then through this channel(s) to the user's ID 20 via the ID 20's connection(s) 24 to the channel(s) 30. In option two, the IC 12 follows a path 11 to 16 in which the IC 12 does not go through the ADMS 10 but goes through the electronic and/or communications channel(s) 30 and then to the user's ID 20 via its connection(s) 24 to the channel 30. It is important to note that with option two, it is possible that the IC 12 will be delivered through an electronic and/or communications channel(s) 30 that differs from that to which the ADMS 10 is delivering other components.

The choice of delivery methods available to the ADMS 10 depends on, but is not limited to: the electronic and/or communications channel(s) location(s) of the IC 12; electronic and/or communication channel(s) or system conditions; or, if more than one option is available, the ADMS 10 may offer the user 40 a choice of delivery methods.

Managing Delivery of Stored Assessment Items

The ADMS 10 contains 21 an AS 15 that includes features for locating 22 the SAI 17 that will be associated with the assessment delivery process. In particular, the AS 15 will locate, within the SAI 17, stored information related to assessment items that were, most likely, created, referenced, linked or otherwise supplied by one party (e.g., teacher) for the purpose of using as part of the assessment process of another party (e.g., students). Information related to the SAI 17 includes, but is not limited to, the electronic and/or communications channel(s) location, such as database, application and/or other file locations, in which the specific SAI 17 resides. The SAI 17 that is accessed is one that has been associated 25 with the SICE 14 that is also part of the assessment delivery process.

The delivery of the SAI 17 occurs by following a path 28 in which the SAI 17 is delivered directly through the ADMS 10 which then manages delivery of the SAI 17 through the ADMS's connection(s) 27 to an electronic and/or communications channel(s) 30 and then through this channel(s) to the user's ID 20 via the ID 20's connection(s) 24 to the channel(s) 30.

Creating Stored Assessment Results

Once a user 40 has completed the actions required within the SAI 17 (e.g., complete test item or items) a SAR 19 is created. The ADMS 10 saves the information as a SAR 19. Each SAR 19 is assigned a unique identifier by the ADMS 10 and is stored by the ADMS 10, via the AS 15, in a storage area that is associated with the ADMS 10.

Upon designation of a SAR 19, the ADMS 10, via the AS 15, associates 29 the SAR 19 with the SAI 17 that was delivered and via the association 25 the SAI 17 has with the SICE 14 that is associated with the delivered IC 12. Consequently, the SAR 19 is also associated 33 with the IC 12. Once created the ADMS 10 may allow the user 40 to retrieve the SAR 19, and if needed, also retrieve its associated IC 12 for later activity.

Accessing and Modifying Stored Assessment Results

It is possible that the user 40 may be permitted to retrieve and/or modify a SAR 19. Such a situation may occur if a user 40 seeks to review and/or make adjustments to a SAR 19 that was previously created. In this situation the ADMS 10 manages delivery of the SAI 17 that will follow a path that first locates and makes available within the SAI 17 its associated 29 SAR 19. Delivery of the SAI 17 will then follow path 28 in which the SAI 17, with the SAR 19 included, is delivered directly through the ADMS 10 which then manages delivery of the SAI 17 and the included SAR 19 through the ADMS's connection(s) 27 to an electronic and/or communications channel(s) 30 and then through this channel(s) to the user's ID 20 via the ID 20's connection(s) 24 to the channel(s) 30.

It should be noted that the process of accessing and/modifying the SAR 19 can result in the ADMS 10 delivering, within a GPS 31, multiple components including a component containing the SAR 19, contained within its associated 29 SAI 17 and a component containing the IC 12 that is associated 25 with the SAI 17. The delivery of the IC 12 is managed by the ADMS 10 in the manner previously discussed and when delivered along with the SAI 17 and the SAR 19 will produce a continuous unified perceptual experience. Consequently, both the SAR 19, contained within the SAI 17, and the IC 12 exist concurrently within the user's ID 20.

Use of Assessments

The assessment items are created by one party and are delivered to another party, the user 40, for the purposes assessing the user 40 (e.g., students, research subjects, employees, etc.). Assessment items may exist in: 1) a plurality of assessment types and response options (e.g., multiple choice, true-false, essay, personal evaluations, file uploading, etc.); 2) a plurality of items within each assessment type (e.g., one or more multiple choice questions, one or more short answer or comment statements, etc.); and 3) in a plurality of electronic or communications formats such as, though not exclusively, text, graphics, animation, interactive communication, video, audio, over-the-air transmission such as television and radio, tactile materials, olfactory materials, and other information formats.

The assessment items, contained within the SAI 17, can be delivered concurrently with its associated IC 12 based on the association 25 between the SICE 14 and the SAI 17. However, this invention does not limit its use to this circumstance. The user 40 could, if they choose and/or if the ADMS 10 allows, have delivered only the SAI 17 itself without the IC 12 (e.g., test without the IC 12). In addition, other features may allow the assessment to be transferred or shared with other users.

Overview Using Technology Components

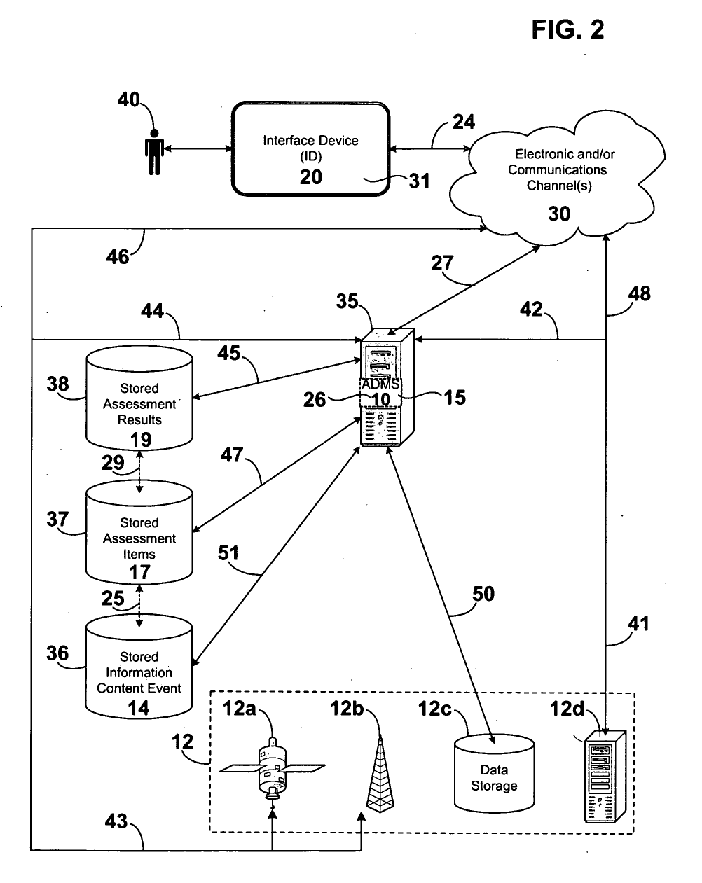

FIG. 2 offers an additional presentation of this invention represented within technology components. The user 40, through an ID 20 accesses, via an electronic and/or communications channel(s) 30, the ADMS 10 that resides within equipment containing an information technology processor 35. The ADMS 10 contains the required electronic tools for delivering and managing assessments including the ICS 26 and the AS 15.

The process of creating stored assessment results includes the ADMS 10 providing and managing delivery, within a GPS 31, to the user's ID 20 a component containing the IC 12, delivered from its electronic and/or communications channel(s) location(s), and a component containing SAI 17. Consequently, both the IC 12 and the SAI 17 exist concurrently within the user's ID 20. The IC 12 and the SAI 17 are, most likely, material created, referenced, linked or otherwise supplied by one party to another party, in this case the user 40.

Locations of Information Content

There are numerous sources in which the IC 12 may reside. These sources include, but are not limited to: a file location(s) that is (are) directly associated with the ADMS 10 such as files stored on data storage devices 12c associated 50 with the ADMS 10 or its related programs and applications; a file location(s) that is (are) outside the location(s) of the ADMS 10 such as, but not exclusively, those located on Local Area Networks, Internet, Intranets, and/or Extranets 12d; communication or frequency location(s) 12b, such as, but not exclusively, radio, television, cellular or other analog or digital communications that are either delivered directly over-air or by wireless means or through wireline hookup; or information provided via satellite communications 12a either delivered directly over-air or by wireless means or through wireline hookup.

Delivery of Information Content

The path of delivery of the IC 12 to the user's ID 20 may occur in one of the following ways:
1. having the IC 12 delivered from an electronic and/or communications channel(s) location(s) stored on a data storage device(s) 12c associated 50 with the ADMS 10 or its related programs and applications, through a path that begins from the storage device(s) 12c through the association 50 between the ADMS 10 and the storage device 12c, through the ADMS 10 located in the technology processor 35, through a connection(s) 27 linking the technology processor 35 containing the ADMS 10 to the electronic and/or communications channel(s) 30, and then to the user's ID 20 through a connection(s) 24 linking the ID 20 to the electronic and/or communications channel(s) 30;
2. having the IC 12 delivered from an electronic and/or communications channel(s) location(s) 12d that include, but are not limited to those located on Local Area Networks, Internet, Intranets, and/or Extranets, through a path 41 to 48 linking the location(s) 12d of the IC 12 to the electronic and/or communications channel(s) 30, and then to the user's ID 20 through a connection(s) 24 linking the ID 20 to the electronic and/or communications channel(s) 30;
3. having the IC 12 delivered from an electronic and/or communications channel(s) location(s) 12d that include, but are not limited to those located on Local Area Networks, Internet, Intranets, and/or Extranets, through a path 41 to 42 connecting the location(s) of the IC 12 to the ADMS 10, then through a connection(s) 27 linking the technology processor 35 containing the ADMS 10 to the electronic and/or communications channel(s) 30, and then to the user's ID 20 through a connection(s) 24 linking the ID 20 to the electronic and/or communications channel(s) 30;
4. having the IC 12 delivered from other electronic and/or communications channel(s) location(s) 12a and 12b such as, though not exclusively, satellite, broadcasting and wireless connections, through a path 43 to 44 connecting the location(s) of the IC 12 to the ADMS 10, then through a connection(s) 27 linking the technology processor 35 contain the ADMS 10 to the electronic and/or communications channel(s) 30, and then to the user's ID 20 through a connection(s) 24 linking the ID 20 to the electronic and/or communications channel(s) 30; or
5. having the IC 12 delivered from other electronic and/or communications channel(s) location(s) 12a and 12b such as, though not exclusively, satellite, broadcasting and wireless connections, through a path 43 to 46 linking the electronic and/or communications channel(s) location(s) of the IC 12 to the electronic and/or communications channel(s) 30, and then to the user's ID 20 through a connection(s) 24 linking the ID 20 to the electronic and/or communications channel(s) 30.
   Path of User Activity

Activity associated with a user 40 creating a SAR 19 travels a path from the ID 20 through a connection(s) 24 between the ID 20 and the electronic and/or communication channel(s) 30, then through a connection 27 linking the electronic and/or communications channel(s) 30 with technology processor 35 containing the ADMS 10. The ADMS 10 then directs the user's activity to the appropriate areas controlled by the ADMS 10.

Information Related to User's Interface Device

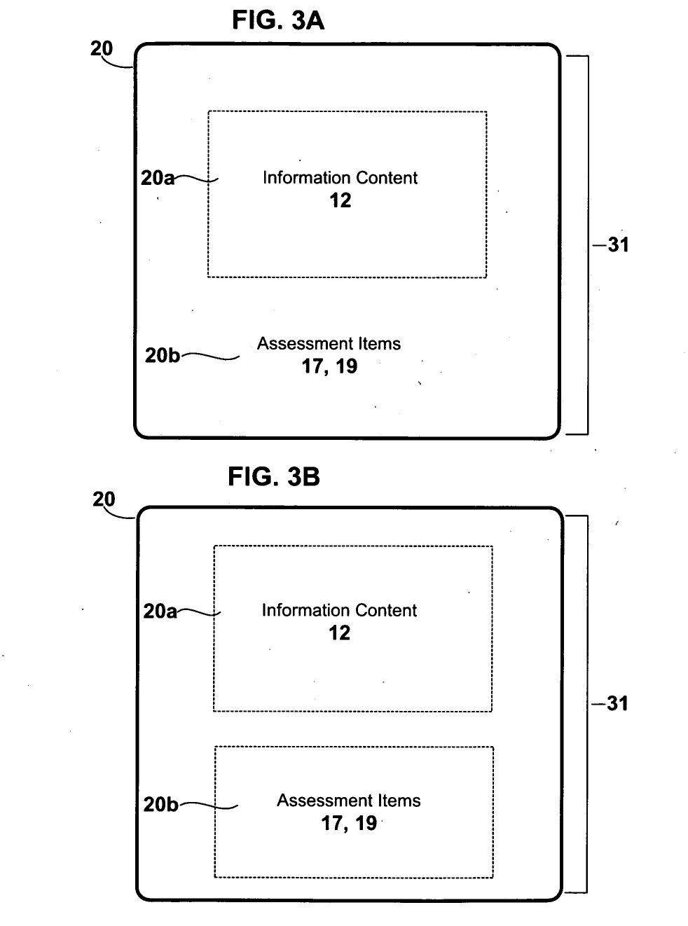

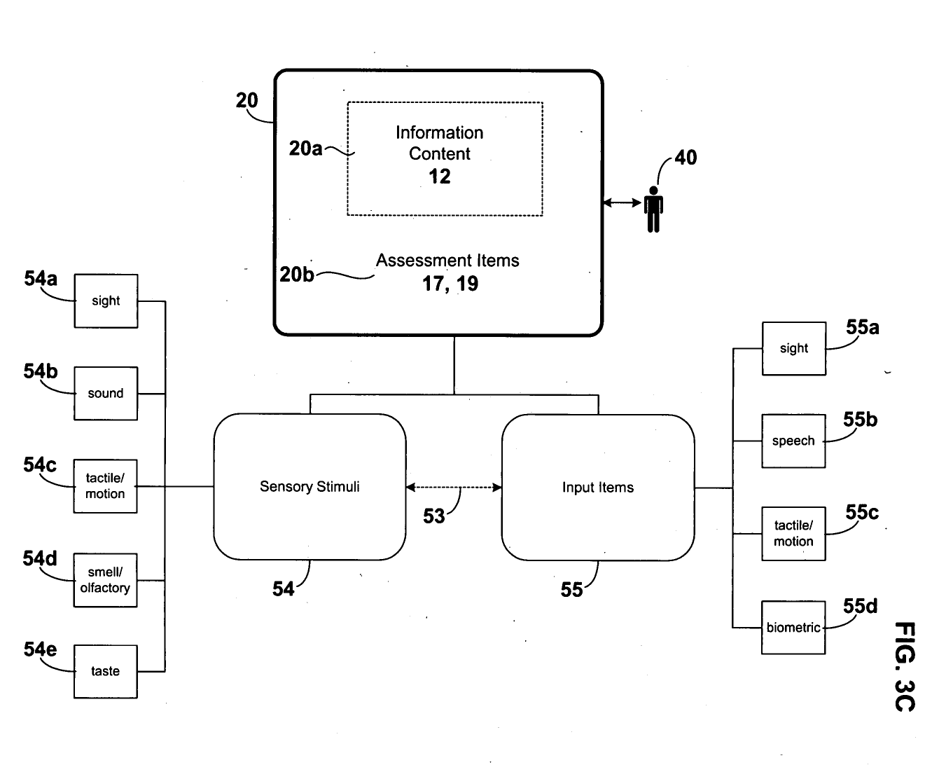

FIG. 3A and FIG. 3B provide more detail on the ADMS's management of information delivered to the user's interface device. The user's ID 20 can be thought of as all connected, interrelated or otherwise associated equipment or devices that allow a user to experience and/or interact with available, authorized and/or otherwise accessible resources available through an electronic and/or communications channel(s).

Now looking at FIG. 1 and FIG. 3A, FIG. 3A shows the results of the delivery to the ID 20 of assessment related components managed by the ADMS 10. The ADMS 10 contains the necessary processes for allowing two or more components to exist concurrently within the ID 20 of the user 40.

In one embodiment, the ADMS 10 presents within the ID 20 a general presentation scheme (GPS) 31 that includes component 20a, containing the IC 12, and component 20b, containing the SAI 17, which may also include the SAR 19 if the user 40 is accessing a previously created SAR 19.

However, a unique aspect of this invention is that the ADMS 10 presents the component 20a, containing the IC 12, as an individualized contained element within the GPS 31. In this form, certain characteristics of component 20a, including but not limited to its dimensions, location, style, behavior, and other presentation aspects, may be controlled by the ADMS 10. Additionally, certain characteristics of the IC 12 itself including but not limited to its behavior, activity, movement, presentation and other aspects may be controlled by the ADMS 10. For example, within a web browser presentation to an ID 20 created using Hypertext Markup Language (HTML), the IC 12 could exist as an individualized contained element within the HTML code as a method to control its presentation within the ID 20. For instance, one method presented in U.S. Pat. No. 5,838,906 could be used to produce the individualized contained element approach, however, those skilled in the art will recognize that other methods and approaches may be able to produce the same individualized contained element effect.

The individualized contained element approach holds advantages over other presentation formats, for instance, that divide web browser pages since individualized contained elements can be controlled by the ADMS 10 via the GPS 31. For example, a popular method for sectioning web pages is to use a coding technique called frames. However, web browser pages using frames may lose control based on the underlying coding of the page that is loaded in the frame. While presentations using HTML are used as an example, other presentation programming languages, codes and methods could also produce a similar experience including but not limited to Extensible Markup Language (XML) and Java.

In the embodiment shown in FIG. 3A, the IC 12 exists within an individualized contained element while the SAI 17 (and possibly the SAR 19), exist not as an individualized contained element but as part of the GPS 31. The nature of the individualized contained element of the IC 12 may offer a measure of control in the presentation within the ID 20 that is not as easily available to the component 20b, containing the SAI 17 (and possibly the SAR 19). For example, the length and width of the component 20a, containing the IC 12, could be controlled by the ADMS 10, within the GPS 31. Conceivably a user 40 would have the ability to adjust certain features of the ID 20 that would affect elements controlled by the GPS 31, including affecting component 20b. Yet the nature of individualized contained element of component 20a containing the IC 12 could potentially prevent such an adjustment from affecting the presentation of component 20a containing the IC 12 and instead this component may stay within the parameters specified by the ADMS 10.

Besides the user 40 being potentially able to make adjustments to the ID 20 that may affect the information delivered by the ADMS 10 within the GPS 31, conceivably adjustments could also be made by those who control the IC 12 itself. Since in some situations the IC 12 is not available at a location or in a form that is controlled by the ADMS 10 (e.g., computer file located on the Internet), it is possible that aspects of its presentation within the ID 20 could be affected by elements outside the control of the ADMS 10. The nature of the individualized contained element of IC 12 managed by the ADMS 10 within the GPS 31 may be able offset or otherwise assist in controlling these outside controls. These examples are representative of just two advantages offered by using individualized contained components in this invention. Those skilled in the art may understand that many other advantages may exist.

Now looking at FIG. 1 and FIG. 3B, FIG. 3B shows an alternative embodiment in which both component 20a, containing the IC 12, and component 20b, containing the SAI 17 (and possibly the SAR 19), are delivered by the ADMS 10, within the GPS 31, as individualized contained components. In this way both components exhibit the same advantages of individualized contained elements as was previously discussed. The current invention does not limit the number of individualized contained elements that may exist. Nor does this invention limit which components must be exist as individualized contained elements. While FIG. 3A shows the IC 12 as the individualized contained component while the SAI 17 does not exist as an individualized contained component, conceivably this could be reversed with the SAI 17 being the individualized contained element while the IC 12 is not.

Potential Other Items Within AS and ICS

In addition to containing the IC 12 and the SAI 17 (and possibly the SAR 19) the ADMS 10, within a GPS 31, may also contain additional information and tools, such as but not limited to: 1) tools or information that provide assistance, instruction and descriptions to the user 40 as they experience the material presented within the ID 20; 2) details or other information regarding the IC 12 to which the SAI 17 is related including its electronic and/or communications channel(s) location(s); 3) providing access to reference materials or tools such as spell checking, grammar checking, dictionary, encyclopedia or other information or links to other information items; 4) providing access to translation tools for translating IC 12 or SAI 17 for the user 40; 5) summarization tools allowing for automatic summarization or categorization of material or activity that the user 40 experiences within the ID 20; 6) summary information or tools that offer the user 40 information related to other users' activity (e.g., class average score); 7) information that related to time completed, time left and other timing measures; and 8) information and tools for allowing user 40 to navigate to other areas within the ADMS 10.

Explanation of Continuous Unified Perceptual Experience

Again relating to FIG. 3A and FIG. 3B, both the IC 12, contained in component 20a, and the SAI 17 and SAR 19, contained in component 20b, whose delivery to the ID 20 is managed by the ADMS 10, within a GPS 31, are presented within the user's ID 20 in a form that produces a continuous unified perceptual experience for the user.

A continuous unified perceptual experience exists when one or more sensory inputs or stimuli are present, either concurrently or in a sequential order, so that the user's overall experience or awareness registers as a single or series of associated and undisturbed events. For the purpose of this invention such an experience takes place within the experience obtained when interacting, either passively or actively, with certain interface devices connected to an electronic and/or communications channel(s). The main principle behind the continuous unified perceptual experience is that the person who is registering the experience when interacting with the interface device is perceiving that the stimuli they are experiencing are linked or unified in manner that suggests to the person that the stimuli are associated with a specific item or application and/or are emanating from a single source. A disruption to the link that establishes the perceived connection of stimuli results in a disruption to the person's perceptual experience. A distinction is not made based on length of time of exposure to the stimuli but on common characteristics that link the stimuli and that these links are relevant within the context of the person's current expectations of the perceptual experience.

For the purpose of this invention, examples may include, but are not limited to: information provided through a single computer application such as a single web browser; programming provided through a single analog or digital wireline broadcast source such as cable sources and programming provided through a single analog or digital wireless broadcast source such over-the-air television and radio, satellite, and other wireless applications. In each of these examples someone whose current perceptual experience is focused on the information (i.e., stimuli) provided by these sources recognizes that these are linked as long as the delivery of the stimuli remains undisturbed within the user's expectations of the perceptual experience.

This can be seen in FIG. 3C, which provides a conceptual representation of potential items that may be included within a user's continuous unified perceptual experience of the preferred embodiment. The overall experience can be divided into two distinct, though interrelated 53, elements. First, there exists sensory stimuli 54 that the user 40 derives from simply being within the presence of the interface device. The sensory stimuli that impact the user's senses include the presence of one or more stimuli dealing with sight 54a, sound 54b, tactical/motion 54c, smell/olfactory 54d, and/or taste 54e. Such items may include, but are not limited to: video screens such as computer and television screens; video projection machines; audio or sound apparatus; scent emitters; items producing vibration or motion; and taste providers.

Second, there exists input items 55 that connect the user 40 to the interface device in a way that permits the user 40 to interact with the sensory stimuli information that is being presented. Such interactive items associated with the ID 20 generally fall, though not exclusively, into items that allow for user 40 interactivity such as those dealing with sight 55a, speech 55b, touch/motion 55c and biometrics 55d. Such items may include, but are not limited to: computer keyboards; other computer input items such as a mouse, scanning devices, input pads or sticks; pupil or eye trackers; remote control devices; and touch sensors.

Performing Activity Within the Interface Device

Now referring to FIG. 2, FIG. 3A, 3B and 3C, the ADMS 10 manages delivery to the user's ID 20 within a general presentation scheme 31 of multiple components, with one embodiment encompassing an individualized contained element in component 20a, in which the IC 12 is contained, and a component containing the SAI 17, which may contain the SAR 19. Another embodiment as shown in FIG. 3B indicates that multiple components may each be an individualized contained element. In FIG. 3B the SAI 17, which may include SAR 19, as an individualized contained element within component 20b, within a general presentation scheme 31 as is component 20a, containing the IC 12. In either embodiment, to the user 40 the components exist within a continuous unified perceptual experience in the ID 20 in which sensory stimuli 54 along with input items 55 are present either concurrently or in relevant sequence order so that the user's overall experience registers as a single or unified event. However, functionally the components 20a and 20b are separate, since these are drawn from separate electronic and/or communications channel(s) location(s), namely the IC 12 is drawn from its location(s) while the SAI 17, which may contain the SAR 19, are drawn from their location(s). The “separate-but-one” experience enables the user 40 to perform activity within one component, using one or more input or interactive mechanisms 55 associated with the ID 20. In this way performing activity within one component will not materially affect the perceptual experience the user 40 is deriving from the component in which activity is not being performed.

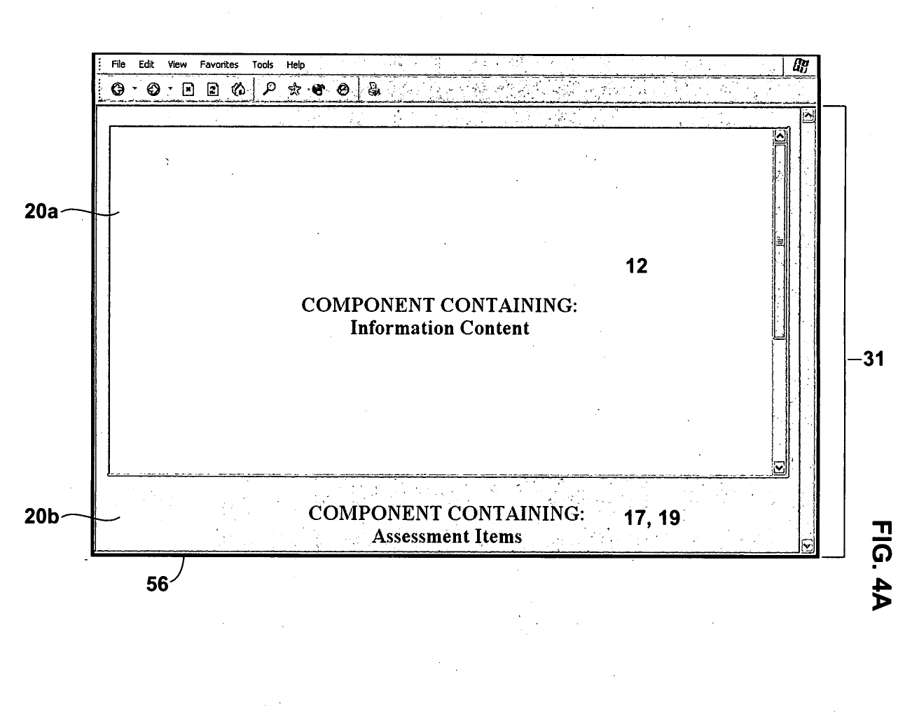

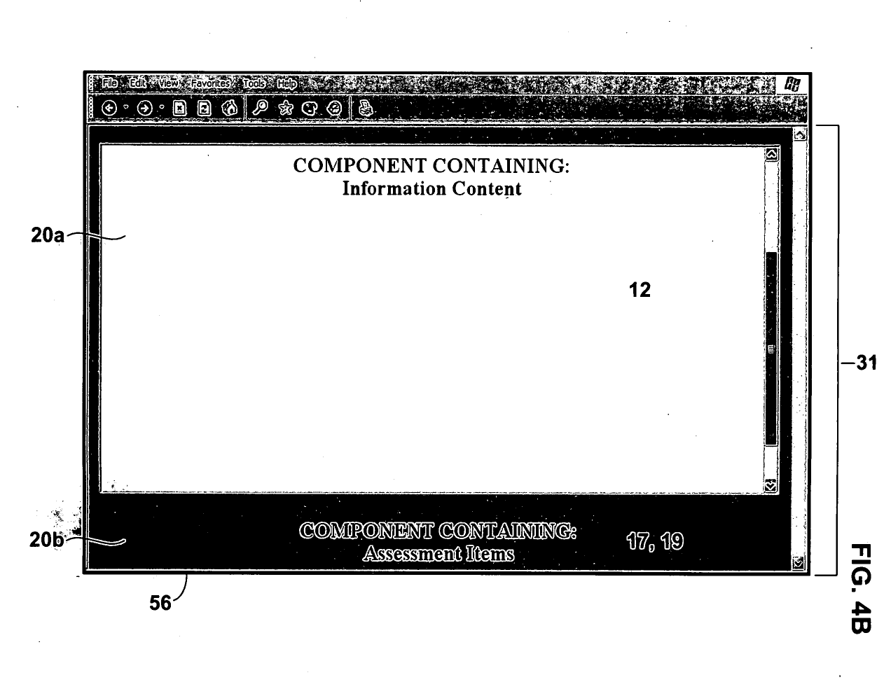

For example, one form for creating stored assessment results is through electronic and/or communications channel(s) that utilize protocols associated with the World Wide Web. In this environment a single web browser may serve as the single application that is providing the continuous unified perceptual experience, including potentially multiple sensory stimuli, within the user's ID 20. As shown in FIG. 4A a single web browser 56 is presented which contains information whose delivery is controlled by the ADMS 10 within a general presentation scheme 31. The representations shows that the component 20a, containing the IC 12, which is associated with the SAI 17, is an individualized contained element within the presentation delivered by the ADMS 10. The delivered information also includes the component SAI 17 which is contained within the general presentation scheme 31 though in this representation it is not presented as an individualized contained component. Finally for situations in which a user 40 is modifying a previously created SAR 19, the SAI 17 will include the SAR 19.

Both components, 20a containing the IC 12 and 20b containing the SAI 17 and possibly SAR 19, contain information drawn from separate electronic and/or communications channel(s) location(s) but appear together within a single web browser 56. With this arrangement the user can separately manipulate one component while the other component remains undisturbed. Using input items associated with the ID 20, the user can move between either component without altering the experience the user obtains from the other component. The act of moving between components 20a and 20b does not disturb the contents of the components unless the user directly manipulates them. The act of performing activity within one component likewise does not alter the user's continuous unified perceptual experience since user interaction is an expectation that exists with the experience (e.g., mouse clicks) associated with using web browsers. It should be noted that the percentage of perceptual experience occupied by a component can be varied by the ADMS 10 within the GPS 31. Each component is not limited to the percentage represented in FIG. 4A or in other drawings presented. Additionally, it may be possible for the ADMS 10 to allow users to intentionally make adjustments to individualized contained components. For instance, the ADMS 10 may allow the user 40 to adjust the dimensions of individualized contained elements.

User Activity Within Web Browser

Looking again at FIG. 4A a before representation is shown of the single web browser 56 prior to certain user activity. FIG. 4B shows an after representation of the same single web browser 56 that appears in FIG. 4A. In both FIG. 4A and FIG. 4B, components 20a, containing IC 12, and component 20b, containing SAI 17 (and possibly the SAR 19), consist of information drawn from separate electronic and/or communications channel(s) location(s).

In the after representation shown in FIG. 4B the user's activity has resulted in an adjustment to the IC 12 leading to the information area being moved upward (i.e., scrolled down). However, by making this adjustment the user has consciously permitted the sensory experience to be altered as part of the interaction process. The single browser 56 containing the multiple components is still displayed and while components 20a, containing the IC 12, has been adjusted in terms of the information area that is now viewable, the single web browser 56 remains within the user's continuous unified perceptual experience.

The representations using web browsers shown in FIG. 4A and FIG. 4B, while useful for effectively understanding the invention, is not limited to this embodiment since other methods may also be employed that do not use a web browser page for delivering the continuous unified perceptual experience.

Other Arrangement of Components

It should be noted that in FIG. 3A and FIG. 3B the arrangement of components controlled by the ADMS 10 within a general presentation scheme 31 and provided within the user's ID 20 represent only one of a plurality of arrangements of components, which are potentially available since there are numerous interface device options that can handle a plurality of different stimuli types and offer a plurality of input devices. In all cases the main objective of the ADMS 10, in terms of delivery, is to produce a continuous unified perceptual experience within the user's ID 20. For instance, while FIG. 3A and FIB. 3B show a horizontal arrangement with component 20a, containing the IC 12, appearing in an upper horizontal area and component 20b, containing the SAI 17 (and possibly the SAR 19), appears the lower horizontal area, it is conceivable that components could be presented vertically. For example, the component 20b, may appear on the left side of a visual ID 20, such as a computer screen or television, and component 20a on the right side. Clearly additional arrangements are possible including those that involve only partial or no visual stimuli. For instance, audio methods may be used to present the IC 12, with the audio being produced within the ID 20 through an audio producing device such as audio speakers. In this embodiment the component 20b, containing the SAI 17, and possibly SAR 19, may appear on a computer screen and thus allows the user to create or modify assessment results while listening to the IC 12. Or to extend this example further, the user could create or modify assessment results using voice recognition technology as an input method in which case neither the IC 12 nor the AS 15 may involve visual stimuli.

Stored Assessment Results Creation Process

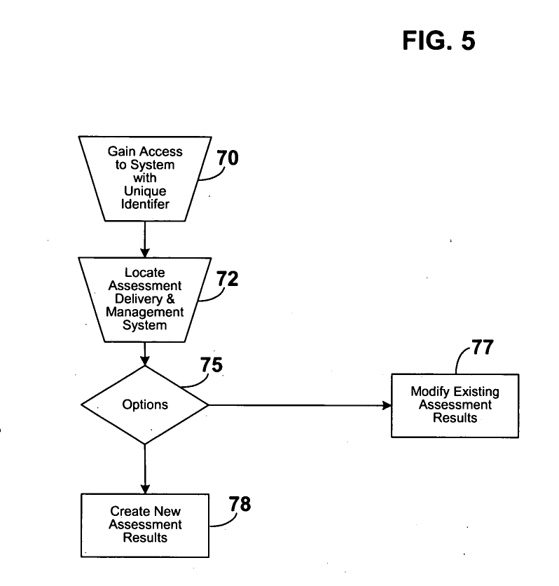

FIG. 5 shows a flow diagram representing the initial stages in the creation of new stored assessment results. The stored assessment results will occur based on activity performed by a user on assessment items. The diagram shows several steps that reflect the flow of information that occurs in order to create or modify assessment information. Now relating information in FIG. 2 with the information in FIG. 5, to gain access to the ADMS 10 the user 40 must enter information 70 (e.g., username, password, other personal identification) that associates the user 40 with an internal unique identifier. The unique identifier allows the ADMS 10 to associate further user 40 action to the user 40 via their unique identifier.

The ADMS 10 may operate as a stand-alone item that is accessed directly or may reside within a more complex offering requiring the user 40 to maneuver to the section containing the ADMS 10. In either situation the user 40 must locate 72 the ADMS 10. Once the user 40 has completed all tasks needed to gain access, the ADMS 10 may present the user 40 with certain options 75 which may include creating new assessment results 78 or modifying existing stored assessment results 77. In either instance, the user 40 must locate the assessment materials on which they will perform activity. The action of locating the assessment material may be passive, in that the ADMS 10 will identify the assessment upon the user's entry into the system or may require user 40 action to locate the assessment.

Creating New Stored Assessment Results

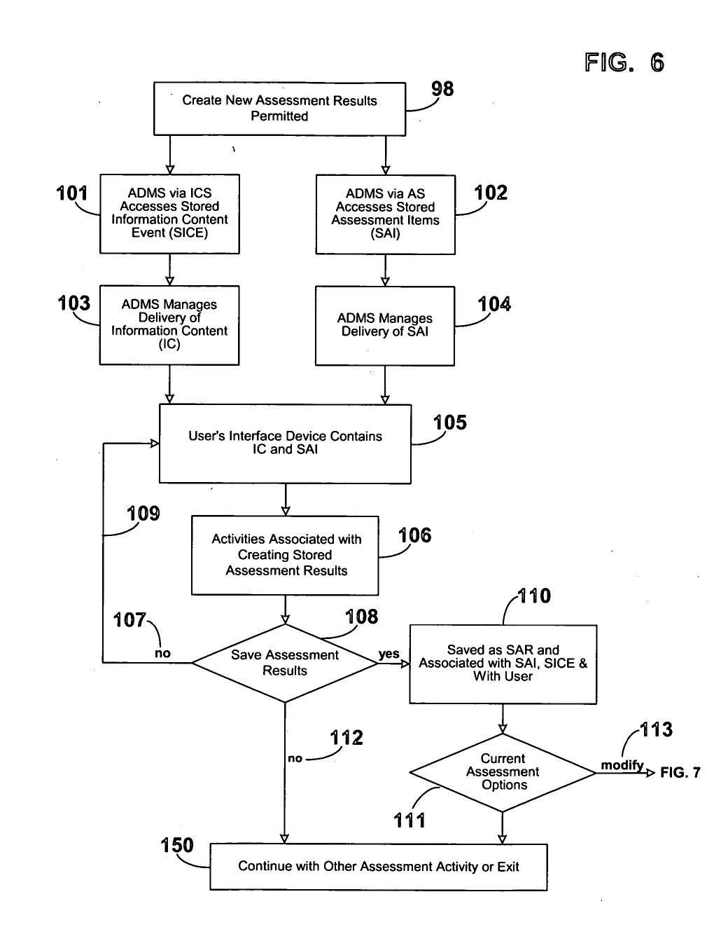

FIG. 6 shows a flow diagram representing the steps carried out in the process of creating new stored assessment results once access to the assessment process has been permitted 98. Now relating FIG. 2 with FIG. 6, to create new SAR 19 the ADMS 10, via the ICS 26, accesses 101 from that part of electronic storage area 36, associated 51 with the ADMS 10, the SICE 14 which includes the electronic and/or communications channel(s) location(s) of the IC 12 for the selected assessment. Next the ADMS 10 manages delivery 103 of the IC 12 to the user's ID 20. Once the IC 12 is either partially or fully retrieved, it is made available 105 to the user 40 through their ID 20 within a general presentation scheme 31 that is managed by the ADMS 10.

Concurrently while the ADMS 10 is carrying out the functions related to the IC 12 described above, it is also accessing 102 via the AS 15 the SAI 17 that is associated 25 with the IC 12. Next the ADMS 10 manages delivery 104 of the SAI 17 to the user's ID 20. The SAI 17 is made available 105 to the user 40 through their ID 20 within a general presentation scheme 31 that is managed by the ADMS 10. For the present invention the form in which the IC 12 and the SAI 17 are presented within the user's ID 20, is one that produces, for the user 40, the previously discussed continuous unified perceptual experience Within the ID 20.

With the IC 12 and the SAI 17 now available through the user's ID 20 the user 40 may begin activities associated with creating stored assessment results 106. As previously discussed, the SAI 17 may consist of a plurality of assessment types and response options, a plurality of items within each assessment type and a plurality of format options. Thus, what is referred to as an assessment may, in fact, consist of a single assessment item (e.g., one question at one time) or many individual assessment items (e.g., many different questions at one time). It may also be the case that material delivered by the ADMS 10 is only a partial representation of a larger assessment (e.g., one question at one time but the assessment will have many questions). Thus the process discussed for creating stored assessment results may be repeated a multiple number of times in order for the user 40 to complete the entire assessment.

At any point during the stored assessment results creation process the ADMS 10, through the AS 15, may allow for saving 108 of the assessment as a SAR 19. The ADMS 10 may allow for user 40 selected saving or may save automatically. If the user 40 chooses to save the assessment or if the ADMS 10, via the AS 15, saves automatically, the ADMS 10 associates 110 the SAR 19 with SAI 17. Referring to FIG. 1, this association is exhibited in 29. In this way the SAR 19 is also associated 33 with the IC 12 via the association 25 between the SAI 17 and the SICE 14. Additionally, all information is associated uniquely with the user 40. Alternatively, the user 40 who wishes not to save or has not yet performed activity that would initiate an automatic save by the ADMS 10 may be permitted 107 to modify an assessment item that had not yet been saved in which case the ADMS 10, via the AS 15, will return 109 the user 40 to the point 105 at which the IC 12 and SAI 17 appear within the user's ID 20. A third save 108 option may allow the user to not save 112 and instead continue with other assessment activity or exit the system 150.

Once again referring to FIG. 2 and FIG. 6, once the SAR 19 is saved, the user 40 may be offered other assessment options 111. First, the ADMS 10 may allow the current SAR 19 to be immediately modified 113. Second, the user 40 may continue with other assessment activity 150 (e.g., answer more questions) for which a SAR 19 is to be created or exit the assessment process. It is also possible that the ADMS 10, via the AS 15, may automatically control the process for continuing assessment activity. In which case the option 111 for continuing or exiting may not be totally under the control of the user 40. If more SAR 19 are to be created then the ADMS 10 may automatically present additional SAI 17 or the ADMS 10 may offer the user 40 a choice to receive additional SAI 17.

Modifying Stored Assessment Results

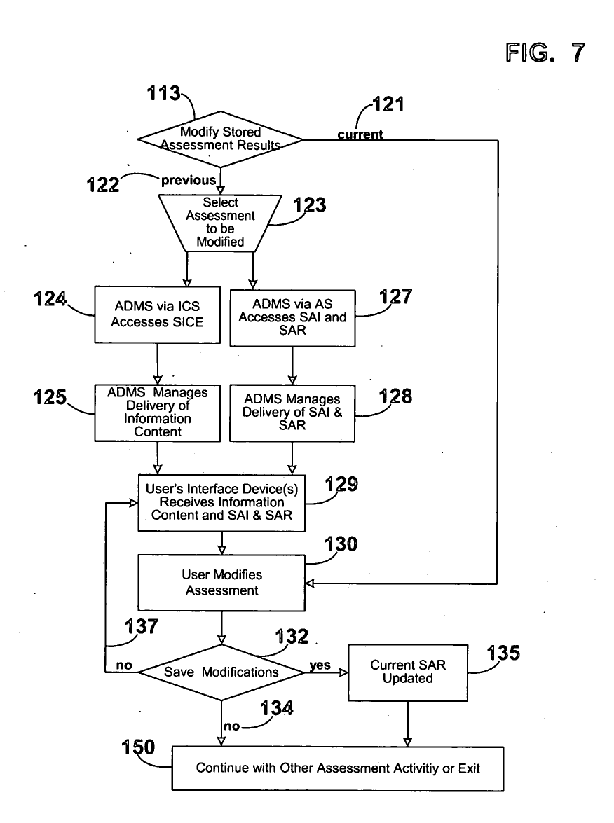

FIG. 7 shows a flow diagram representing the steps carried out in the process of modifying previously stored assessment results. The ADMS 10 may allow modification to take place on either a currently available assessment 121 or on a previously stored assessment 122.

Modify Stored Assessments—Not Currently Available

Now referring to FIG. 5, in the case where a previously stored assessment is not currently available, the user must maneuver to that part of the ADMS 10, which contains the option 75 that includes modifying existing assessment results 77.

Now referring to FIG. 2 and FIG. 7, the ADMS 10 may allow the user 40 to make modifications to the SAR 19 contained within the SAI 17. Modifications may include changes, additions and/or deletion to a selected SAR 19 such as, but not limited to, changing responses or activity, enhancing existing responses or activity, adding new responses or activity and deleting responses or activity.

Upon choosing the option to modify 122 a previous SAR 19, the user 40 must then choose 123 the SAR 19 that is to be modified. Once the user 40 has selected the assessment to be modified the ADMS 10, via the ICS 26, locates 124 the SICE 14 from that part of electronic storage area 36, associated 51 with the ADMS 10 and that is associated 25 with the selected SAI 17. Next the ADMS 10 manages delivery 125 of the IC 12, which is identified within the SICE 14, to the user's ID 20. Once the IC 12 is either partially or fully retrieved, it is made available 129 to the user 40 through their ID 20 within a general presentation scheme 31 that is managed by the ADMS 10.

Concurrently while the ADMS 10 is carrying out the functions related to managing the delivery of the IC 12 described above, it is also accessing via the AS 15 the SAI 17 from the storage area 37 associated 47 with the ADMS 10 that is assigned to the user 40. In addition to accessing the SAI 17, the ADMS 10 also accesses the SAR 19, that is associated 29 with the SAI 17, from the storage area 38 associated 45 with the ADMS 10 that is assigned to the user 40. The ADMS 10 then manages delivery 128 of the SAI 17, which contains the SAR 19, to the user's ID 20. The SAI 17 and its contents are made available 129 to the user 40 through the ID 20 within a general presentation scheme 31 that is managed by the ADMS 10. For the present invention the form in which the IC 12 and the SAI 17, containing the SAR 19, are presented to the user's ID 20, is one that produces, for the user 40, the previously discussed continuous unified perceptual experience within the ID 20.

With the IC 12 and the SAI 17, which contains the SAR 19, now available through the user's ID 20, the user 40 may begin to make modifications 130 to the assessment.

When the user 40 has finished modifications to the assessment the ADMS 10, via the AS 15, offers the user 40 the option 132 to save the modifications. If the user 40 chooses to save the modifications the ADMS 10 replaces certain information in the current SAR 19 in which case the modifications are saved in place of the existing information 135. By doing so all other identifiers and associations, such as the unique identifiers assigned when the SAR 19 was originally created, may remain unchanged or will be updated so these will again be associated in the same fashion as previously developed.

If a user's choice for the save modifications option 132 is not to save, the user 40 may return 137 to the modification process 129 or if the user 40 wishes to not continue with the modifications and not save what has been done 134, the ADMS 10 may allow the user 40 to continue with other assessment activities or exit the assessment process 150. It is also possible that the ADMS 10, via the AS 15, may automatically control the process for continuing assessment activity. In which case the option 150 for continuing or exiting may not be totally under the control of the user 40. For instance, the ADMS 10 may require the user 40 to complete a series of tasks prior to ending the assessment modification process. For example, while the ADMS 10 may allow for modification of individual assessment items one-at-a-time, the ADMS 10 may require the user to cycle through all questions on a certain assessment prior to exiting the assessment process.

Modify Stored Assessments—Currently Available

FIG. 6 indicates that a user 40 may be permitted to modify 113 an SAR 19 that is currently being acted on and that has been saved. As shown in FIG. 7 modifications to a current assessment 121 results in the ADMS 10 allowing the user to move directly to the modification step 130. Once modification is permitted the process for modifications of the currently available assessment is the same as discussed above for assessments that were previously created but are not currently available.

Continuing Assessment Process for Creation of Stored Assessment Results

FIG. 8 presents a flow diagram showing the events that may occur once stored assessment results have been created and the user 40 is now presented with the next step 150. One option is that the user 40 may exit 152 from the assessment process. Another option that may be available is to continue with the assessment process which may include the creation of additional stored assessment results 153. In this situation the ADMS 10 may automatically present additional assessment information or the ADMS 10 may offer the user 40 a choice to receive additional assessment information. Additionally, in the situation in which assessment items are presented in a series (i.e., complete action on one or a group of assessment items before moving to next assessment item or items) the ADMS 10 may offer the ability 170 to deliver the new SAI 17 but retain the same IC 12 that was present in the user's ID 20 for the assessment that immediately preceded the new assessment item. Alternatively the ADMS 10 has ability 154 to deliver a new IC 12 along with the new SAI 17.

Delivering New Assessment Items with New Information Content

As shown in FIG. 8 at 154, the delivery of the next assessment item(s) along with new information content occurs in a similar fashion as was seen in the process of creating stored assessment results in FIG. 6. Now relating FIG. 2 with FIG. 8, to create a new SAR 19 the ADMS 10, via the AS 15, accesses 155 additional assessment item(s) within the SAI 17 that are associated 25 with a IC 12 through the SICE 14. Next the ADMS 10 manages delivery 157 of the SAI 17 to the user's ID 20. Once the SAI 17 is either partially or fully retrieved, it is made available 159 to the user 40 through their ID 20 within a general presentation scheme 31 that is managed by the ADMS 10.

Concurrently while the ADMS 10 is carrying out the functions related to the SAI 17 described above, it is also accessing 156, via the ICS 26, from that part of electronic storage area 36, associated 51 with the ADMS 10 that is assigned to the user 40, the SICE 14 which includes the electronic and/or communications channel(s) location(s) of the IC 12 for a selected assessment item(s). Next the ADMS 10 manages delivery 158 of the IC 12 to the user's ID 20. Once the IC 12 is either partially or fully retrieved, it is made available 159 to the user 40 through their ID 20 within a general presentation scheme 31 that is managed by the ADMS 10.

For the present invention the general presentation scheme 31 in which the IC 12 and the SAI 17 are presented to the user's ID 20, is one that produces, for the user 40, the previously discussed continuous unified perceptual experience within the ID 20.

With the IC 12 and the SAI 17 now available through the user's ID 20 the process for completing the tasks follows the same process as was shown in FIG. 6. For clarity the process is presented again in FIG. 8. The user 40 may begin activities associated with creating stored assessment results 160. At any point during the stored assessment results creation process the ADMS 10, through the AS 15, may allow for saving 161 of the assessment as a SAR 19. The ADMS 10 may allow for user 40 selected saving or may save automatically. If the user 40 chooses to save the assessment or if the ADMS 10, via the AS 15, saves automatically 165, the ADMS 10 associates 180 the SAR 19 with SAI 17. Referring to FIG. 1, this association is exhibited in 29. In this way the SAR 19 is also associated 33 with the IC 12 via the association 25 between the SAI 17 and the SICE 14. Additionally all information is associated uniquely with the user 40. Alternatively, the user 40 who wishes not to save or has not yet preformed activity that would initiate an automatic save by the ADMS 10 may be permitted 162 to modify an assessment item that had not yet been saved in which case the ADMS 10, via the AS 15, will return 163 the user 40 to the point 159 at which the IC 12 and SAI 17 appear within the user's ID 20. A third save 161 option may allow the user to not save 164 and instead continue with other assessment activity or exit the system 150.

Once again referring to FIG. 2 and FIG. 8, once the SAR 19 is saved 165 and the ADMS 10 makes the necessary associations 180, the user 40 may be offered other assessment options 185. First, the ADMS 10 may allow the current SAR 19 to be immediately modified 183. Second, the user 40 may continue with other assessment activity 150 (e.g., answer more questions) for which a SAR 19 is to be created in which case the process shown in FIG. 8 may be repeated or the user 40 may exit the assessment process. It is also possible that the ADMS 10, via the AS 15, may automatically control the process for continuing assessment activity. In which case the option 185 for continuing or exiting may not be totally under the control of the user 40.

Delivering New Assessment Items with Same Information Content

FIG. 8 at 170 shows that another option 153 related to presenting new assessment items is for the ADMS 10 to deliver new assessment items but retain the existing IC 12. Now relating FIG. 2 with FIG. 8, in this situation the IC 12 would remain in the user's ID 20 while the ADMS 10, via the AS 15, accesses 171 additional assessment items that are associated 25 with the IC 12. Next the ADMS 10 manages delivery 172 of the SAI 17 to the user's ID 20. The SAI 17 is made available 173 to the user 40 through their ID 20 within a general presentation scheme 31 that is managed by the ADMS 10. For the present invention the general presentation scheme 31 in which the IC 12 and the SAI 17 are presented to the user's ID 20, is one that produces, for the user 40, the previously discussed continuous unified perceptual experience within the ID 20.

With the IC 12 and the SAI 17 now available through the user's ID 20 the process for completing the tasks follows the same process as was shown in FIG. 6. For clarity the process is presented again in FIG. 8. The user 40 may begin activities associated with creating stored assessment results 160. At any point during the stored assessment results creation process the ADMS 10, through the AS 15, may allow for saving 175 of the assessment as a SAR 19. The ADMS 10 may allow for user 40 selected saving or may save automatically. If the user 40 chooses to save the assessment or if the ADMS 10, via the AS 15, saves automatically 181, the ADMS 10 associates 180 the SAR 19 with SAI 17. Referring to FIG. 1, this association is exhibited in 29. In this way the SAR 19 is also associated 33 with the IC 12 via the association 25 between the SAI 17 and the SICE 14. Additionally all information is associated uniquely with the user 40. Alternatively, the user 40 who wishes not to save or has not yet preformed activity that would initiate an automatic save by the ADMS 10 may be permitted 184 to modify an assessment item that had not yet been saved in which case the ADMS 10, via the AS 15, will return 177 the user 40 to the point 173 at which the IC 12 and SAI 17 appear within the user's ID 20. A third save 175 option may allow the user to not save 182 and instead continue with other assessment activity or exit the system 150.

Once again referring to FIG. 2 and FIG. 8, once the SAR 19 is saved 181 and the ADMS 10 makes the necessary associations 180, the user 40 may be offered other assessment options 185. First, the ADMS 10 may allow the current SAR 19 to be immediately modified 183. Second, the user 40 may continue with other assessment activity 150 (e.g., answer more questions) for which a SAR 19 is to be created in which case the process shown in FIG. 8 may be repeated or the user 40 may exit the assessment process. It is also possible that the ADMS 10, via the AS 15, may automatically control the process for continuing assessment activity. In which case the option 185 for continuing or exiting may be not be totally under the control of the user 40.

Visual Representation of Process for Creating Stored Assessment Results

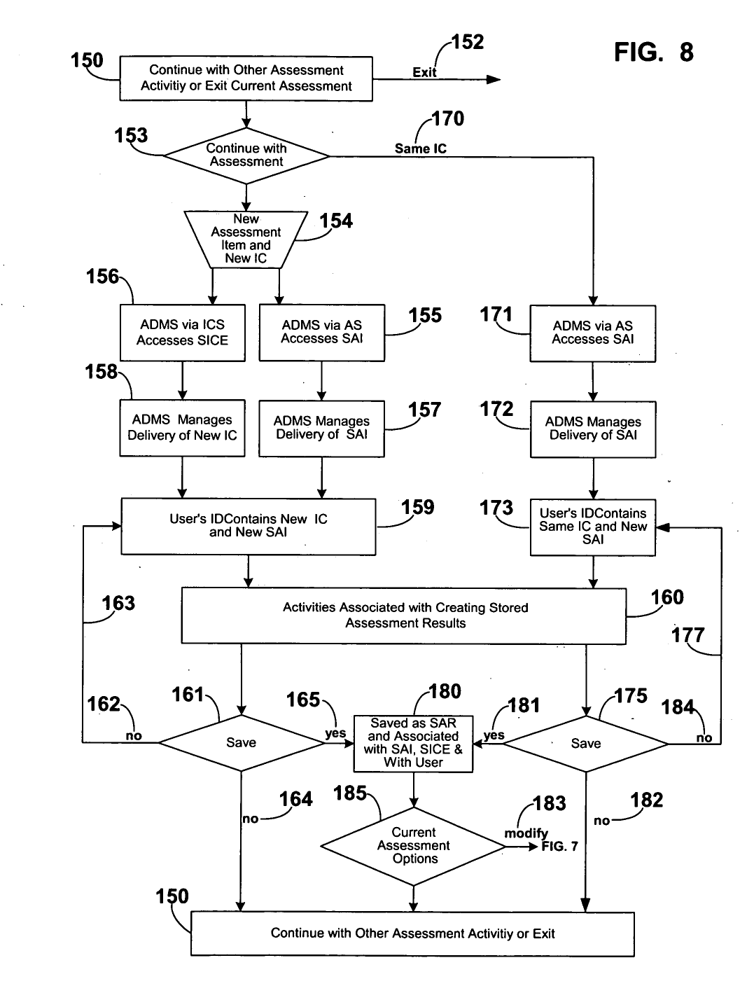

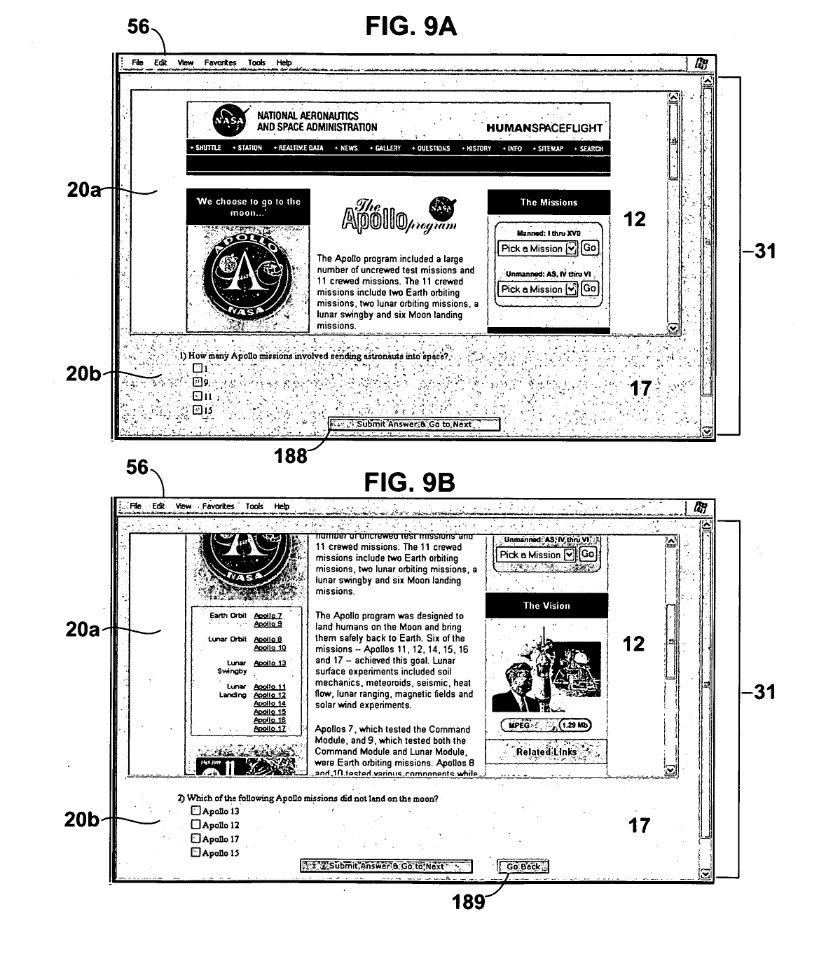

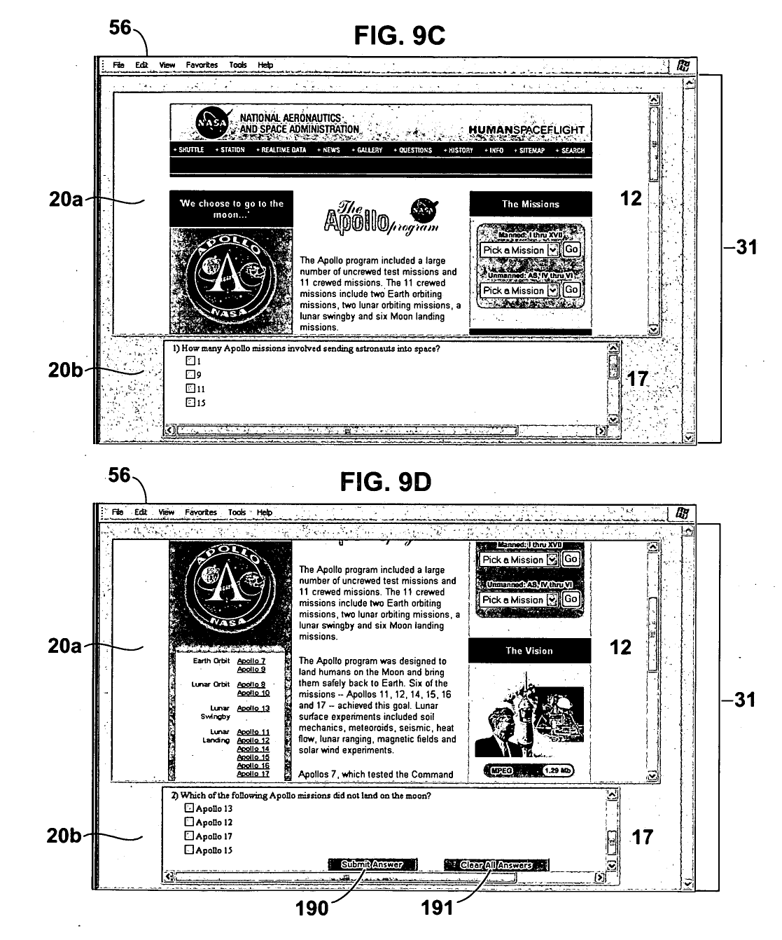

FIG. 9A through FIG. 9D present a visual representation of the assessment results creation process as it may appear within the continuous unified perceptual experience embodied in a single web browser. The representation, while useful for effectively understanding the invention, is not limited to these embodiments since other methods may also be employed that do not use a web browser page for delivering the continuous unified perceptual experience. The representation within the web browser also assumes the possible presence of other items associated with the interface device that involve sensory experience and input. For instance, in this representation the user is creating the assessment using an interface device(s) connected to an electronic and/or communications channel(s). The user interacts with the interface device via input devices that include a keyboard and a computer mouse and, in addition to visual stimuli, may also receive stimuli from other sources such as via audio and motion.

These representations deal with creating stored assessment results after the user has maneuvered through the ADMS 10 and is permitted to create the stored assessment results. These representations are not intended to show the entire process for developing stored assessment results, rather, the intention of the representations is to isolate and describe certain aspects of the invention in order to convey basic understanding.

FIG. 9A presents a single web browser 56 which contains information whose delivery is controlled by the ADMS 10 within a general presentation scheme 31. The representation shows that component 20a, containing the IC 12, which is associated with the SAI 17, is an individualized contained element within the GPS 31 managed by the ADMS 10. The delivered information also includes the component 20b, containing the SAI 17, which is contained within the general presentation scheme 31, though in this instance component 20b is not represented as an individualized contained component. Both components, IC 12 and SAI 17, contain information drawn from separate electronic and/or communications channel(s) location(s). In this example component 20a, containing the IC 12, represents electronic information drawn from one source (i.e., NASA web site) and component 20b, containing the SAI 17, is drawn from the source containing the ADMS 10 and its associated storage areas. The ADMS 10, via the AS 15, presents the user with the necessary materials for creating SAR 19, in this case questions though those skilled in the art will recognized that a plurality of other methods and means of assessment may be utilized. In FIG. 9A the ADMS 10, indicates that to create the stored assessment result the user must click on the Submit Answer & Go to Next button 188, though other methods or graphic representations could be used. Although not shown, the ADMS 10, via the AS 15, could provide additional instruction to the user for each assessment item (e.g., “Select the best answer”, “Select two answers”, “Rank these in order”, etc.)

FIG. 9B shows the results of the user's decision to Submit Answer & Go to the Next as the assessment delivery and management system delivers, via the SAI 17 in general presentation component 31, the next assessment item. This is just one of a plurality of results that may occur when the user creates the SAR 19. For instance, other outcomes may include but are not limited to: 1) providing immediate feedback to the user regarding their SAR 19 (e.g., indicate if correct or incorrect), 2) providing suggestions, comments, or other information to user based on their SAR 19 (e.g., suggest area to re-read or review based on answer), 3) indicating standings, scoring or other measures of results or progress either individually or within a group, or 4) ending the assessment process. Additionally, FIG. 9B shows that other options may exist within the SAI 17. These may include, though are not limited to, the option 189 to return to a previous question. In this case the use of this option 189 may allow the user 40 to modify previous questions.

A comparison of FIG. 9A with FIG. 9B shows that the IC 12 in component 20a is the same in both FIG. 9A and 9B, though activity performed on component 20a in FIG. 9B has resulted in an adjustment to the IC 12 leading to the information area being moved upward (i.e., scrolled down) within the browser. The single browser 56 containing the multiple components is still displayed and while component 20a, containing the IC 12, has been adjusted in terms of what information is now viewable, the single web browser 56 remains within the user's continuous unified perceptual experience. The user can switch to the IC 12 in component 20a using an input mechanism and can work within this component. For example, as is shown in FIG. 9B, the user scrolled lower in the IC 12, however, doing so is within the user's continuous unified perceptual experience since it is part of the process of interacting with the web browser. Interacting with the IC 12 within component 20a does not affect the status of the experience the user is deriving from the SAI 17 in component 20b, which is unaffected by the user switching to the IC 12 in component 20a.

In this example, the IC 12 has remained the same, and in this case, the IC 12 is not altered when the user selects the Submit Answer & Go to Next button and the ADMS 10, via the AS 15, provides the next assessment item. In this way the user can, if they choose, evaluate the material in the IC 12 contained in component 20a while creating a SAR 19 in component 20b. Working in the SAI 17 in component 20b does not affect the user's experience with the IC 12 in component 20a. The view of the IC 12 contained in component 20a is not blocked or disturbed by the user working in the AS 15 in component 20b.

Continuing with the representation, FIG. 9C shows an embodiment in which there are two components, 20a, containing the IC 12, and 20b, containing the SAI 17, in which each exists as an individualized contained element managed by the ADMS 10 within the GPS 31. In this case the user can switch between components and perform activity separately in each without disturbing the other component. FIG. 9D shows that user activity has resulted in an adjustment to the IC 12, with the information area being moved upward and to the SAI 17 where the user can move through multiple assessment items prior to creating stored assessment items. In this case the user has entered information within the SAI 17 contained in component 20b without affecting the IC 12 contained within component 20a. The SAR 19 would be created upon the users choice to click on the Submit Answer button 190, though other methods or graphic representations could be used. Although not shown, the ADMS 10, via the AS 15, could provide additional instruction to the user for each assessment item (e.g., “Select the best answer”, “Select two answers”, “Rank these in order”, etc.). Additionally, FIG. 9D shows that other options may exist within the SAI 17. These may include, though are not limited to, the option 191 to remove all answers and allow the user to start the process over.

While embodiments presented show conditions with a single individualized contained component and another example showing two components that each exist as individualized contained elements, this invention is not limited to these options. Those skilled in the art will recognize that a plurality of individualized contained components are possible and still remain with in the continuous unified perceptual experience set forth in this invention.

Other Embodiments

It will be appreciated by those skilled in the art that the foregoing has set forth the presently preferred embodiment of the invention and an illustrative embodiment of the invention, but that numerous alternative embodiments are possible without departing from the novel teachings of the invention. For example, referring to FIG. 2, in another embodiment of the invention the information presented to the user 40 within their ID 20 may consist of more than two separate sources. In addition to the IC 12, and the SAI 17, the ADMS 10 may manage delivery of additional components that assist in the process of creating assessment results. For instance, the IC 12, the SAI 17, and possibly the SAR 19, may each be divided into more than one component. Thus it is conceivable that the ID 20, as shown in FIG. 3A and FIG. 3B may consist of three or more components and the ADMS 10 manages delivery of each in a manner that produces the previously discussed continuous unified perceptual experience.

Also, referring to FIG. 2, the current preferred embodiment shows the ADMS 10 resides within equipment containing an information technology processor 35 that is accessible via an electronic and/or communications channel(s) 30. In another embodiment, the ADMS 10 and its associated components such as, but not exclusively, the ICS 26 and the AS 15, may resides within equipment containing an information technology processor that is associated with the user 40. For example, the ADMS 10 may reside on the user's computer. In this case access to the ADMS 10 need not require access over an electronic and/or communications channel(s) 30. However, while in this embodiment access to the ADMS 10 does not occur over an electronic and/or communications channel(s), access to an electronic and/or communications channel(s) may be required in order for the ADMS 10 to carry out certain functions, most notably, managing the delivery of the IC 12. This would be the case unless all IC 12 rest on equipment or components that are associated with the equipment containing the ADMS 10 and that do not require the use of an electronic and/or communications channel(s) to access.

Also, an embodiment may exist in which the ADMS 10 not only creates SAR 19 based on the users activity within a given SAI 17, but the ADMS 10 may also be able to track the user's activity within a given IC 12. Examples may include but are not limited to: 1) monitoring click behavior; 2) measuring usage time within the IC 12; and 3) monitoring number of visits or re-visits to an IC 12.

Also, an embodiment may exist in which the user may consist of multiple users that are working together or in a collaborative way to create stored assessment results. In this case the ADMS 10, via the AS 15, may offer assessment items whose purpose allows for collaborative response options such as, but not limited to, file sharing, real-time discussion, and other interactive communication methods.

Also, an embodiment may exist in which the ADMS 10, via the AS 15, requires the user 40 to perform certain activities in a preplanned arrangement. For instance, the ADMS 10, may require that the user 40 complete activity within the IC 12 (e.g., watch a video) prior to allowing the user to complete the activity with the SAI 17 (e.g., respond to questions).

Also, referring to FIG. 2, an embodiment may exist in which some elements of the SAI 17 may not reside within a storage area 37 that is associated 47 with the ADMS 10. Rather, some of the elements may exist outside the ADMS 10 in locations such as those indicated in 12a, 12b and 12d. In this way the ADMS 10, via the AS 15, may register the electronic and/or communications channel(s) location of the SAI 17 and mange the delivery of the SAI 17 to the user's ID 20. It is also conceivable that while some or all of the SAI 17 is located and delivered from locations outside the ADMS 10, that SAR 19, that is associated 29 with the SAI 17 would be delivered by the ADMS 10 via the process described in this invention. Thus, while the SAI 17 may be delivered from a location outside the ADMS 10 the SAR 19 contained within the SAI 17 may be delivered from within the ADMS 10.

Additional Applications

Another application of the current invention is to aid in evaluative processing in situations in which one party must offer feedback, comments, suggestions and other information-providing methods to another party, when offering these requires the presence of information content. For instance, one party may produce information content that must be evaluated by another party. If the material is available via an electronic and/or communications channel(s) to the party who is creating the evaluation then the method and process of this invention can be utilized. In this circumstance, the assessment system would be replaced by an evaluation control system, which assists in locating and providing access to evaluation items that are used to create stored evaluation results. As with the present invention involving assessment delivery and management, the information content, for which the user is developing stored evaluation results, and the evaluation items would have their delivery to the user's interface device managed by the delivery and management control system discussed in this invention. The delivery to the user's interface device would be presented in a form that produces a continuous unified perceptual experience for the user. Also, as with the present invention, the information content and the evaluation items would exist and be delivered from separate electronic and/or communications channel(s) locations.

Conclusion, Ramification and Scope

The present invention provides a method utilizing electronic and/or communications channel(s) for allowing a user to create stored assessment results while in the presence of certain information content in a way that provides a continuous unified perceptual experience. Such a method allows a user to create and modify assessment results while experiencing the information content, which most likely is either directly or indirectly the subject or purpose for creating an assessment. In the absence of such a method those creating or modifying assessment results over electronic and/or communications channel(s) face problems as they move between information content and assessment items. These disadvantages primarily occur due to the requirement that users make physical and/or mental adjustments or manipulations that at one point in time brings the information content within their sensory experience and another adjustment or manipulation to bring assessment items into their sensory experience. The act of bringing one of these items into the user's perceptual experience requires that the other item depart the user's perceptual experience either in part or in full.

For example, existing methods available to users who create assessment results in this way require the user to refer to information content in ways that include but are not limited: relying on memory, looking at printed material, or switching between different computer screens. These methods offer disadvantages that include but are not limited to: error in memory, data input errors due to requirements for physical manipulations, out-of-date information, added costs, additional time and inconvenience.

The current invention addresses the disadvantages of existing methods for delivering and managing assessments over an electronic and/or communications channel(s) by providing both the information content and the assessment items within a continuous unified perceptual experience. Additionally, the present invention addresses potential problems that may arise in cases where it is advantageous to present both information content and assessment items concurrently within a user's interface device by offering a general presentation scheme that includes the utilization of individualized contained components. Thus, advantages of this invention include, but are not limited to: faster completion time, less costly, lower error rates, increased convenience and greater control within individualized contained elements. In addition, conceivably user's may be able to develop more effective assessments results and possibly improve learning since the information content is readily available while the user is completing assessment items.

1. A method for delivering and managing assessment comprising:
providing access through a user's interface device to an assessment delivery and management system;
managing the delivery to said user's interface device of multiple components, including a component containing information content and a component containing assessment items,
having said delivery to said user's interface device of multiple components, including a component containing information content and a component containing assessment items occur via electronic and/or communications channel or channels;
providing a format in which said multiple components within said user's interface device is presented in a manner that produces a continuous unified perceptual experience and allows for user activity to occur in any single component of the said multiple components;
allowing the user to perform activity within said component containing said assessment items while said information content remains within the said component containing said information content;
designating assessment results upon said user's completion of said perform activity within said component containing said assessment items;
providing storage of said assessment results;
associating the said assessment results with the said user;
associating the said assessment results with said assessment items;
associating said assessment results with said information content; and
permitting modifications of said assessment results.

2. The method of claim 1, wherein said electronics and/or communications channel or channels comprises information technology networks and sources including local area networks, Internet, Intranet, Extranets and local equipment; and communication networks and sources including digital and analog over-the-air transmissions, wireless transmissions, cable transmissions, and satellite transmissions.

3. The method of claim 1, wherein said interface device comprises all connected, interrelated or otherwise associated equipment or devices that allow said user to experience and/or interact with other available, authorized and/or otherwise accessible resources within said electronic and/or communications channel or channels.

4. The method of claim 1, wherein said assessment delivery and management system resides within components containing an information technology processor and associated components that is accessed via said electronic and/or communications channel or channels.

5. The method of claim 1, wherein said assessment delivery and management system resides within components containing an information technology processor and associated components that is local to said user and not accessed via said electronic and/or communications channel or channels.

6. The method of claim 1, wherein said information content comprises:
information used in the process of educating, training, instructing, researching, informing and/or information gathering; and
information available in a plurality of formats including text, graphics, video, interactive communication, animation, audio; over-the-air transmission such as television and radio; tactile materials, olfactory materials, and other information formats.

7. The method of claim 1, wherein said information content comprises information located and accessible through said electronics and/or communications channel or channels.

8. The method of claim 1, wherein said assessment items comprise:
materials used by one party to evaluate, test, gather, measure and other methods used to gain insight into another party's understanding, knowledge, comprehension, attitudes, perceptions, progress, skill development, memory and other assessment criteria; and
materials supplied by another party including that developed by another party, that supplied but not developed by another party, and that referenced or linked by another party to other sources.

9. The method of claim 1, wherein said assessment items comprise a plurality of different assessment items types and a plurality of items within each said assessment items types.

10. The method of claim 9, wherein said assessment items types can include a plurality of formats and response options such as text, graphics, video, interactive communication, animation, audio, over-the-air transmission such as television and radio, tactile materials, olfactory materials, and other information formats.

11. The method of claim 1, wherein said assessment items allow for additional information including directions, information related to said information content and descriptions.

12. The method in claim 1, wherein said perform activity within said component containing said assessment items can include the transfer of materials within said electronics and/or communications channel or channels.

13. The method in claim 12, wherein said materials within said electronics and/or communications channel or channels may exist in locations not directly associated with said assessment delivery and management system.

14. The method in claim 1, wherein said perform activity within said component containing said assessment items may require said user to complete activities within other said multiple components before completing said activity within said component containing said assessment items.

15. The method of claim 1, wherein said multiple components exist concurrently within said user's interface device.

16. The method of claim 1, wherein said delivery to said user's interface device of multiple components can occur with each components being delivered via the same said electronics and/or communications channel or channels or with different components being delivered via different said electronics and/or communications channel or channels.

17. The method of claim 1 wherein each single component within said multiple components contains information drawn from separate electronic and/or communications channel or channels location or locations.

18. The method in claim 1, wherein said continuous unified perceptual experience comprises all sensory stimuli or outputs that are present within said user's interface device, either concurrently or in logical order, and producing a single or series of associated and undisturbed events.

19. The method of claim 1, wherein said user activity within a said single component of said multiple components occurs while information remains available in other components.

20. The method of claim 1, wherein said user activity to occur in any single component comprises allowing activities to be performed within one said component while all other said components remain materially undisturbed.

21. The method of claim 1, wherein said user activity to occur in any single component comprises allowing activities to be performed within one said component while intentionally intending to alter the information in other components.

22. The method of claim 1, wherein one or more components of said multiple components reside as an individualized contained component or components within said format provided by said assessment delivery and management system.

23. The method of claim 22, wherein said individualized contained component or components comprise items whose characteristics within said interface device including its dimensions, location, style, behavior and presentation aspects are controlled by said assessment delivery and management system.

24. The method of claim 1, wherein said alteration of said assessment results occurs within said continuous unified perceptual experience.

25. The method in claim 1, wherein said user consists of a single individual or a group of individuals.

26. The method in claim 25, wherein said group of individuals may access said assessment delivery and management system from more than one and different said interface devices connected to said electronics and/or communications channel or channels.

27. An assessment delivery and management system, comprising:
assessment system for identifying, locating, providing access, associating, and otherwise maintaining information related to assessment items;
information content system for identifying locating, providing access, associating, and otherwise maintaining an information content event that includes information related to information content including the electronic and/or communications channel or channels location or locations of said information content;
means for managing the delivery to a user's interface device of multiple components with the minimum consisting of a component containing said assessment items and a component containing said information content;
means for formatting said delivery to user's interface device of multiple components in a manner consistent with a continuous unified perceptual experience and allows for activities performed by a user to occur in any single component of the said multiple components;
means for designating assessment results upon said user saving activity related to said assessment items;
storage areas for retaining said information content event, said assessment items and said assessment results;
means for associating said assessment items with said information content via said information content event;
means for associating said assessment results with said assessment items;
means for allowing modification to said assessment results; and
means for associating with said user said activities performed by said user within said assessment delivery and management system.

28. The system of claim 27, wherein said electronic and/or communications channel or channels comprise information technology networks and sources including local area networks, Internet, Intranet, Extranets and local equipment; and communication networks and sources including digital and analog over-the-air transmissions, wireless transmissions, cable transmissions, and satellite transmissions.

29. The system in claim 27, wherein said assessment delivery and management system resides within components containing an information technology processor and associated components.

30. The system in claim 27, wherein said components containing an information technology processor and associated components are accessed via said electronic and/or communications channel or channels.

31. The system in claim 27, wherein said components containing an information technology processor and associated components are local to said user and not accessed via said electronic and/or communications channel or channels.

32. The system in claim 27, wherein said assessment items include:
a plurality of assessment items types and a plurality of items within each said assessment items types; and
the inclusion of additional information such as directions, information related to said information content and descriptions.

33. The system in claim 32, wherein said assessment items types includes a plurality of formats and response options such as text, graphics, video, interactive communication, animation, audio; over-the-air transmission such as television and radio; tactile materials, olfactory materials, and other information formats.

34. The system in claim 27, wherein said information content comprises:
information used in the process of educating, training, instructing, researching, informing and/or information gathering; and
information in a plurality of formats including text, graphics, video, interactive communication, animation, audio, over-the-air transmission such as television and radio, tactile materials, olfactory materials, and other information formats.

35. The system in claim 27, wherein said information content comprises information located and accessible via said electronics and/or communications channel or channels.

36. The system of claim 27, wherein said information related to information content including the electronic and/or communications channel or channels location or locations of said information content consists of either the direct or the indirect location or locations of said information content.

37. The system of claim 27, wherein said interface device comprises all connected, interrelated or otherwise associated equipment or devices that allow said user to experience and/or interact with other available, authorized and/or otherwise accessible resources within said electronic and/or communication channel or channels.

38. The system in claim 27, wherein said delivery to a user's interface device of multiple components occurs via said electronic and/or communications channel or channels.

39. The system in claim 27, wherein said delivery to a user's interface device of multiple components can occur with each component being delivered via the same channel or with different components being delivered via different channels.

40. The system of claim 27, wherein said continuous unified perceptual experience comprises all sensory stimuli or outputs that are present within said user's interface device, either concurrently or in logical order, and producing a single or series of associated and undisturbed events.

41. The system of claim 27, wherein one or more components of said multiple components reside as an individualized contained component or components within said formatting said delivery to user's interface device of multiple components.

42. The method of claim 41, wherein said individualized contained component or components comprise items whose dimensions, location, style, behavior and presentation aspects within said interface device are controlled by said assessment delivery and management system.

43. The method in claim 42, wherein said assessment delivery and management system may allow for said user to make adjustments related to said individualized contained component or components.

44. The method in claim 27, wherein said allow for activities performed by a user to occur in any single component of said multiple component items may require said user to complete activities within other said multiple components before completing said activities within said component containing said assessment items.

45. The method in claim 27, wherein said user consists of a single individual or a group of individuals.

46. The method in claim 45, wherein said group of individuals may concurrently access said assessment delivery and management system from more than one and different said interface devices connected to said electronics and/or communications channel or channels.

47. The system in claim 27, wherein said assessment items can also be made available within said user's interface device without the presence of said information content component.
